(19) United States
(12) Patent Application Publication
(10) Pub. No.: US 2007/0210993 A1
(43) Pub. Date: Sep. 13, 2007

(54) Drive device and drive method of display panel

(75) Inventors: Masaki Murakata, Yonezawa-shi (JP); Shuichi Seki, Yonezawa-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOHOKU PIONEER CORPORATION, Yamagata (JP)

(21) Appl. No.: 11/654,554

(22) Filed: Jan. 18, 2007

(30) Foreign Application Priority Data
Mar. 10, 2006 (JP) 2006-065486

(51) Int. Cl. G09G 3/30

(52) U.S. Cl. 345/76

(57) ABSTRACT

In a drive device of a display panel, a write operation (Ws, We) for writing display data into a frame memory and a read operation (a, a′ to h, h′) for reading the display data written in the frame memory are performed. An implementation start timing a of the read operation is set to be after an implementation start timing Ws of the write operation, and an implementation end timing a′ of the read operation is set to be upon or after an implementation end timing We of the write operation. The read operation is performed a plurality of times during one frame period.

### BACKGROUND OF THE INVENTION

1. Field of the Invention

The present invention relates to a drive device and a drive method of a display panel in which tearing generated by allowing write timing of display data for an image memory to get ahead of read timing can be prevented in a drive device of a display panel in which light-emission control of a display panel is implemented employing one frame image memory.

2. Description of the Related Art

In an image display device adopted in a relatively small terminal equipment, for example, such as a cellular telephone, a PDA (Personal Digital Assistant), and the like, from the viewpoint of cost, power consumption, parts mounting space, and the like, a structure provided with one screen (one frame) image memory (frame memory) is adopted.

In order to implement a display operation of an image using the above-described structure, a write operation in which display data is written in a frame memory and a read operation in which the display data is read out of the frame memory are performed during the same one frame period.

In a display device in which gradation control is performed by dividing one frame period into a plurality of subframes, the read operation is implemented a plurality of times during the same frame period. In this case, due to the influence of the vestige of the analog gradation method in which the so-called cathode-ray tube or the like is employed, and due to reasons that the drive frequency of an IC is suppressed, the read operation is implemented a plurality of times while the write operation is implemented during the entire one frame period.

FIG. 1 is to explain write timing and read timing of data for the above-described conventional frame memory. As shown in FIG. 1, the write operation for the frame memory is implemented during the entire one frame period. Accordingly, as shown in FIG. 1, in the end of one frame period, all is rewritten to new display data which corresponds to this frame (which is shown as a new frame in FIG. 1).

The read operation from the frame memory is also implemented a plurality of times during one frame period as shown by reference characters a to h in FIG. 1. As a result, as shown in FIG. 1, the write operation of the display data gets ahead of the read operation so that in the display data read out by the read operation, display data of a prior frame (which is shown as an old frame in FIG. 1) and new display data (new frame) are mixed. As a result, a screen may be divided in the vertical direction, or a tearing phenomenon that is manifested by distortion or flicker in the screen occurs.

In order to prevent the above trouble, Japanese Patent Application Laid-Open No. S62-11889 proposes that an image memory of two screens is used so that write timing and read timing of display data are controlled so as not to generate the above overtaking. Further, Japanese Patent Application Laid-Open No. H10-161842 proposes means for simplifying write timing and read timing of display data, utilizing an image memory of two screens or more.

However, in the structures disclosed in the above-described Japanese Patent Application Laid-Open No. S62-11889 and Japanese Patent Application Laid-Open No. H10-161842, an image memory of at least two screens has to be prepared, so that image display devices such as the cellular telephone and PDA have a problem that such structures are hard to be adopted due to cost and the like.

Meanwhile, in this type of display device, by having PLE (Peak Luminance Enhancement) control means by which an Average Picture Level (APL) of a video signal to be displayed is found in order to control display intensity in the display device by this average picture level, it is expected that low power consumption of the display device can be realized.

In this PLE control, for example, the average picture level (APL) of the video signal which corresponds to entire one frame screen is detected, and based on this average picture level, a display intensity level that is an intensity level for actually performing image display is set.

In this case, in the PLE control, in a case where the average picture level is low (in a case where an entire image is dark) even though a video signal has the same intensity level, a display intensity level is set to a high level so that high intensity display is executed. On the other hand, in a case where average picture level is high (in a case where an entire image is bright), a display intensity level is set to a low level so that power consumption is suppressed. In this manner, the PLE control is performed so that low power consumption can be realized and that an image having an excellent contrast can be displayed.

As described above, a display device provided with the PLE control means by which the average picture level APL of a video signal to be displayed is found and in which the display intensity is controlled by this APL is shown in the following Japanese Patent Application Laid-Open No. H9-281927 and Japanese Patent Application Laid-Open No. 2001-175220 and the like.

Meanwhile, in the PLE control also, in the case where the APL is computed utilizing one frame memory, the APL is computed based on display data of one frame which is one frame earlier than said frame, and according to the result thereof, control of the intensity of the next frame is performed so that a drift of one frame occurs even though the calculation result of the APL value is reflected in the intensity control.

Further, as already described, in the display device in which gradation control is performed by dividing one frame period into a plurality of subframes, a drift of one subframe occurs even though the calculation result of the APL value is reflected in the intensity control. That is, as shown in FIG. 2, when the APL value is calculated in the timing starting from, for example, reference character a, the PLE control is realized in a subframe which starts from the next reference character b.

Similarly, when an APL value is calculated in the timing starting from, for example, reference character b, the PLE control is realized in a subframe which starts from the next reference character c. As a result, since the APL is calculated based on data in which data of one earlier frame (old frame) and data of a new frame are mixed, there is a problem that calculation result of APL is not accurate.

### SUMMARY OF THE INVENTION

The present invention has been developed, paying attention to the above problem, and it is a first object of the present invention to provide a drive device and a drive method of a display panel in which the tearing can be prevented from being generated while a small capacity video memory is utilized.

Further, it is a second object of the present invention to provide a drive device and a drive method of a display panel in which the tearing can be prevented from being generated while a small capacity video memory is utilized, and in which based on a calculated value of the APL which is based on data of one frame to be displayed, the PLE control of this frame can be realized.

A drive device of a display panel according to the present invention which has been developed in order to resolve the first problem is a drive device of a display panel in which a write operation for writing display data into a frame memory and a read operation for reading the display data written in the frame memory are performed during one frame period, and is constructed such that an implementation start timing of the read operation is set to be after an implementation start timing of the write operation, such that an implementation end timing of the read operation is set to be upon or after an implementation end timing of the write operation, and such that the read operation is performed a plurality of times during one frame period.

Further, a drive device of a display panel according to the present invention which has been developed in order to resolve the second problem is the drive device of the display panel which is constructed such that an APL operation in which a mean intensity level of display data written in the frame memory is calculated is performed at least one time during one frame period in addition to the above-described structure.

A drive method of a display panel according to the present invention which has been developed in order to resolve the first problem is a drive method of a display panel in which a write operation for writing display data into a frame memory and a read operation for reading the display data written in the frame memory are performed during one frame period, characterized in that an implementation start timing of the read operation is set to be after an implementation start timing of the write operation, in that an implementation end timing of the read operation is set to be upon or after an implementation end timing of the write operation, and in that the read operation is performed a plurality of times during one frame period.

Further, a drive method of a display panel according to the present invention which has been developed in order to resolve the second problem is the drive method of the display panel, characterized in that an APL operation in which a mean intensity level of display data written in the frame memory is calculated is performed at least one time during one frame period in addition to the above-described drive method.

### BRIEF DESCRIPTION OF THE DRAWINGS

FIG. 1 is a timing diagram for explaining write and read operations of display data with respect to a conventional frame memory;

FIG. 2 is a timing diagram for explaining a conventional APL calculation operation;

FIG. 3 is a block diagram showing an embodiment of a drive device in which the present invention can be adopted;

FIG. 4 is a circuit structure diagram showing an exemplary structure of a pixel arranged in the display panel shown in FIG. 3;

FIG. 5 is a timing diagram for explaining a PLE operation in the drive device shown in FIG. 3;

FIG. 6 is a block diagram for explaining the function of an intensity setting utilized in the structure shown in FIG. 3;

FIG. 7 is a timing diagram for explaining a first example of write and read operations of display data according to the present invention;

FIG. 8 is a timing diagram for explaining a second example, similarly;

FIG. 9 is a timing diagram for explaining a first example of the APL calculation operation according to the present invention; and

FIG. 10 is a timing diagram for explaining a second example, similarly.

### DESCRIPTION OF THE PREFERRED EMBODIMENTS

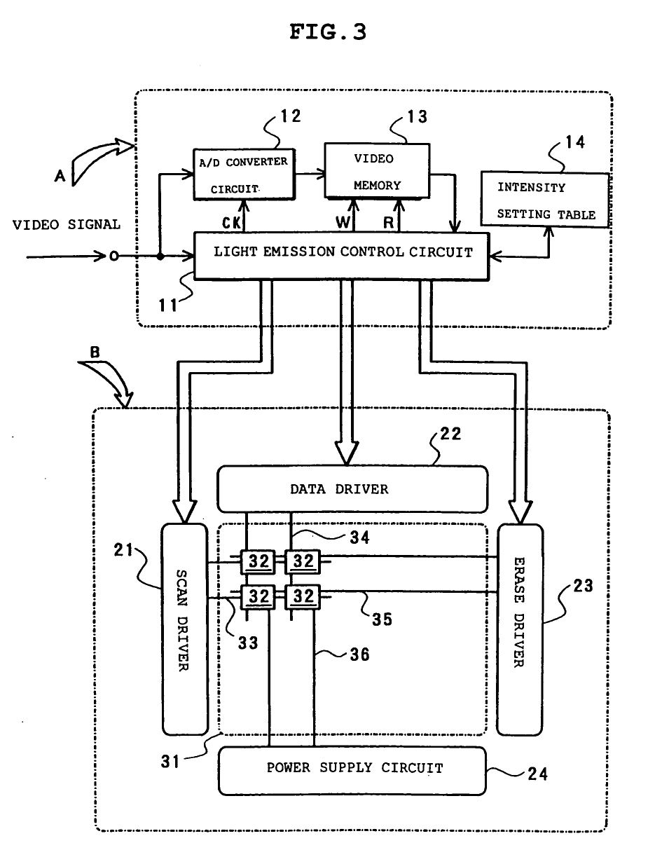

A drive device of a display panel according to the present invention will be described below based on embodiments shown in FIGS. 3 to 6. First, FIG. 3 shows its basic structure by a block diagram, and shows an example of a display drive device which is subjected to an active matrix type display panel in which organic EL (electro-luminescent) elements are employed for pixels of the display panel.

In FIG. 3, reference character A shows light emission control means, and reference character B shows video display means including a display panel, so that a drive device of a display panel according to the present invention is composed of these A and B. In the light emission control means A, a light emission control circuit 11 functioning as a central control circuit is provided, and an A/D (analog-to-digital) converter circuit 12, a video memory 13, and an intensity setting table 14 are connected to this light emission control circuit 11.

The embodiment shown in this FIG. 3 is constructed such that an analog video signal is supplied to the light emission control circuit 11 and the A/D converter circuit 12. The light emission control circuit 11 generates a clock signal CK for the A/D converter circuit 12 and a write control signal W and a read control signal R for the video memory 13 based on horizontal and vertical synchronization signals in the analog video signal.

The light emission control circuit 11 operates to generate a synchronization signal for a scan driver 21, a data driver 22, and an erase driver 23 in the video display means B based on the horizontal and vertical synchronization signals in the video signal.

The A/D converter circuit 12 samples the inputted analog signal based on the clock signal CK supplied from the light emission control circuit 11, and operates to convert this to display data for each pixel to supply this to the video memory 13. The video memory 13 operates to write respective display data supplied from the A/D converter circuit 12 sequentially in the video memory 13 by the write control signal W supplied from the light emission control circuit 11.

The video memory 13 functions as a frame memory in which display data of one frame can be written. That is, by the write operation, data of one screen (one frame) in a later-written display panel is written, and thereafter display data of next one frame is rewritten sequentially to be stored (overwritten).

At the same time as this, display data written in the video memory (hereinafter referred to also as frame memory) 13 is sequentially read out of the memory 13 by the read control signal R supplied from the light emission control circuit 11, and the image thereof is displayed on the display panel in a state in which display control by a subframe method and intensity control by PLE are received as described later herein.

The light emission control circuit 11 reads display data written in the frame memory 13 in synchronization with respective subframe periods which will be described later herein, and supplies a display data signal to the data driver 22. The light emission control circuit 11 also operates to calculate APL from display data written in the frame memory 13. In this case, the APL is obtained by calculating, from display data written in the frame memory 13, pixels, intensity, and the rate of gradation value (light-emission rate) regarding which light emission control is performed in a later-described display panel 31. Therefore, the light emission control circuit 11 also performs a function as light-emission rate calculating means.

Further, the light emission control circuit 11 operates to refer to the intensity setting table 14 based on the calculated light-emission rate to implement a PLE operation. In this PLE operation, the light emission control circuit 11 operates to refer to the intensity setting table 14 based on the light-emission rate to generate an appropriate control signal for the data driver 22 and the erase driver 23 constituting the video display means B. Operations of the data driver 22 and the erase driver 23 at this time will be described later in detail.

Next, reference numeral 31 in the video display means B shows a display panel in which a large number of pixels 32 each of which contains an organic EL element are arranged in a matrix pattern. In this display panel 31, a scan line 33, a data line 34, and an erase signal line 35 which are connected to the above-described scan driver 21, the data driver 22, and the erase driver 23, respectively, are arranged, and at these intersecting points the pixels 32 including the EL elements are arranged, respectively. The display panel 31 is constructed in such a way that a pixel light-emission drive voltage is supplied from a power supply circuit 24 to the respective pixels 32 via a power supply line 36.

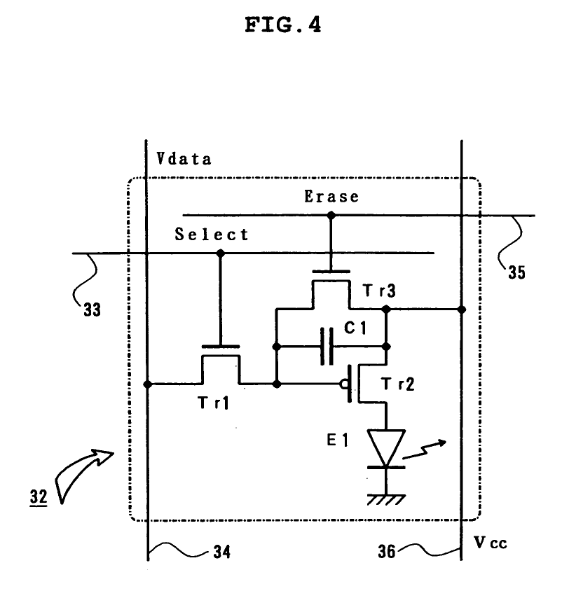

FIG. 4 shows a circuit configuration corresponding to one pixel 32 arranged in the display panel 31, and the pixel 32 is constructed such that a data signal Vdata corresponding to a display command signal sent from the data driver 22 is supplied to the source of a control TFT, that is, a data writing transistor Tr1, via the data line 34 arranged in the display panel.

A scan signal Select (referred to also as a write pulse) is supplied to the gate of the data write transistor Tr1 via the scan line 33 connected to the scan driver 21. The drain of the data write transistor Tr1 is connected to the gate of a light-emission drive TFT, that is, a light-emission drive transistor Tr2 and to one terminal of a charge-retaining capacitor C1.

The source of the light-emission drive transistor Tr2 is connected to the other terminal of the capacitor C1, and is constructed such that a drive voltage Vcc is supplied to the source via the power supply line 36. The drain of the light-emission drive transistor Tr2 is connected to the anode terminal of the organic EL element E1, and the cathode terminal of this organic EL element E1 is connected to a reference potential (ground).

Further, an erase signal Erase (referred to also as an erase pulse) is supplied from the erase driver to the gate of an erase transistor Tr3 as an erase TFT via the erase signal line 35. The source and drain of the erase transistor Tr3 are connected to both ends of the capacitor C1, respectively.

In the circuit configuration of the pixels 32 shown in FIG. 4, only the drive transistor Tr2 is constructed by a p-channel type TFT, and the other elements are constructed by n-channel type TFTs. A large number of pixels 32 of the above-described configuration are arranged in a matrix pattern in the column and row directions as shown in FIG. 3 to construct the display panel 31.

In the structure of the pixels 32 shown in FIG. 4, a write pulse Select as a scan signal is supplied from the scan driver 21 to the gate of the control transistor Tr1 during an address period. Thus, current corresponding to the data signal Vdata supplied from the data driver 22 flows to the capacitor C1 via the source and drain of the control transistor Tr1 so that the capacitor C1 is charged. Its charged voltage is supplied to the gate of the drive transistor Tr2, and the transistor Tr2 allows the current corresponding to its gate voltage and the drive voltage Vcc supplied to the drain to flow in the EL element E1 so that the EL element E1 emits light.

When applying of the write pulse for the gate of the control transistor Tr1 is stopped, the transistor Tr1 is so-called cut-off. However, the gate voltage of the drive transistor Tr2 is maintained by stored charges in the capacitor C1, and thus drive current to EL element E1 is maintained. Accordingly, EL element E1 can continue a light-emitting state corresponding to the data signal Vdata during a period until a next address operation (one subframe period later described).

Meanwhile, during a light-emitting period of the EL element E1 (during one subframe period), the erase pulse Erase by which the erase transistor Tr3 is turned on is supplied from the erase driver 23. Thus, charges charged in the capacitor C1 can be erased (discharged) instantaneously. As a result, the drive transistor Tr2 is in a cut-off state, and the EL element E1 is extinguished immediately. In other words, by controlling the output timing of the erase pulse Erase from the erase driver 23, the light-emitting period in one frame of the EL element E1 is controlled, so that predetermined gamma characteristics and dimmer characteristics can be realized.

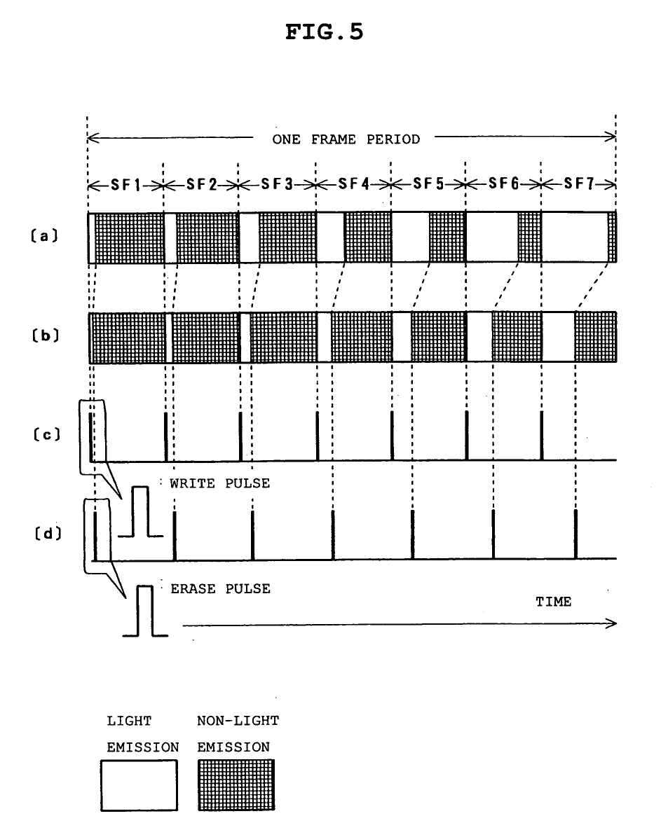

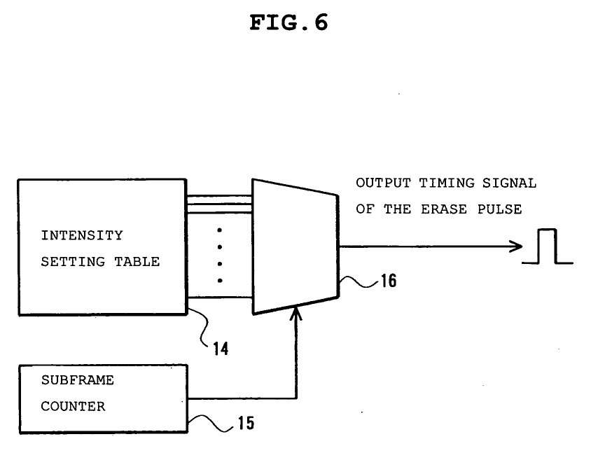

FIG. 5 explains PLE control performed by the structure shown in FIGS. 3 and 4. When this PLE control is realized, in this embodiment, as described above, adopted is gradation control means by which one frame period is divided into a plurality of subframes so that gradation control is realized by the total of light-emitting periods of pixels in this subframe.

That is, the example shown in FIG. 5 shows an example in which one frame period is divided into seven subframes (SF1 to SF7) in order to simplify explanation and in which respective subframes in one frame are selected so that eight gradation expressions (100% non-light-emission also can be deemed as one gradation to give 7+1 gradation expressions) can be realized.

In FIG. 5, [a] and [b] show an example in which the rates of light-emitting periods and non-light-emitting periods for respective subframes are controlled in accordance with light-emission rates of the pixels 32 arranged on the display panel 31 (light-emission rates of pixels written in the memory 13). That is, in FIGS. 5[a] and [b] show a case wherein the rate of the light-emitting period for respective subframes is high and a case wherein the rate of the light-emitting period for respective subframes is low, respectively. Both [a] and [b] show an example in which both [a] and [b] has the same gamma value in the gradation characteristics and in which dimmer characteristics thereof are changed.

Here, in a case where the light-emission rate of the pixels is low (in other words, a case where the APL is low), the light-emission control shown in FIG. 5[a] is executed, and in a case where the light-emission rate of the pixels is high (a case where the APL is high), the light-emission control shown in FIG. 5B is executed. In short, in accordance with the degree of the light-emission rate of the pixels, control is implemented such that the rate of the light-emitting period for respective subframes changes between [a] and [b] of FIG. 5. Thus, specifically in a case where the light-emission rate of the pixels is high, the total of the light-emitting periods of the pixels during one frame period is kept low so that the drive current value supplied to each pixel can be restricted.

In FIGS. 5(c) and (d) explain generation timing of the write pulse and erase pulse in the case where the light-emission control shown in FIG. 5[b] is realized. That is, in the example shown in FIG. 5, the write pulse shown in FIG. 5(c) is generated in synchronization with the starts of respective subframes, and thus the pixels are in the light-emission state. The erase pulse shown in FIG. 5(d) is generated during the passing of the subframe, so that the pixels are in a non-light-emission state.

Here, for example, in a case where gradation “8” is to be realized, a series of light-emission patterns shown in FIG. 5[a] or FIG. 5[b] are executed for pixels during one frame period. Further, for example, in a case where gradation “5” is to be realized, the light-emission drive operation is executed during SF1 to SF4 shown in FIG. 5[a] or FIG. 5[b], and all of the following respective subframe periods SF5 to SF7 are in an extinction state. Thus, a light emission intensity in accordance with the total of the light-emitting periods of the pixels during one frame period can be obtained.

The erase pulse shown in FIG. 5(d) can be generated by the structure shown in FIG. 6 as described below. Reference numeral 15 in FIG. 6 denotes a subframe counter, reference numeral 16 a logical processing unit, and reference numeral 14 the intensity setting table shown in FIG. 3. That is, the intensity setting table 14 is attached externally to the light emission control circuit 11 as shown in FIG. 3, and the subframe counter 15 and the logical processing unit 16 are incorporated into the light emission control circuit 11.

In the intensity setting table 14, light-emitting periods for respective subframes are stored as parameters, corresponding to the light-emission rate. When a subframe number whose light-emission control should be implemented is supplied from the subframe counter 15 to the logical processing unit 16, the logical processing unit 16 accesses the table 14 and operates to generate an output timing signal of the erase pulse based on the parameters of light-emitting periods stored in accordance with the subframe number.

This is generated as the output timing signal of the erase pulse for each subframe respectively in response to the light-emission rate of the pixels as shown in FIG. 5(d). This timing signal is supplied to the erase driver 23, and the erase pulse is outputted from the erase driver 23 for each subframe as described above.

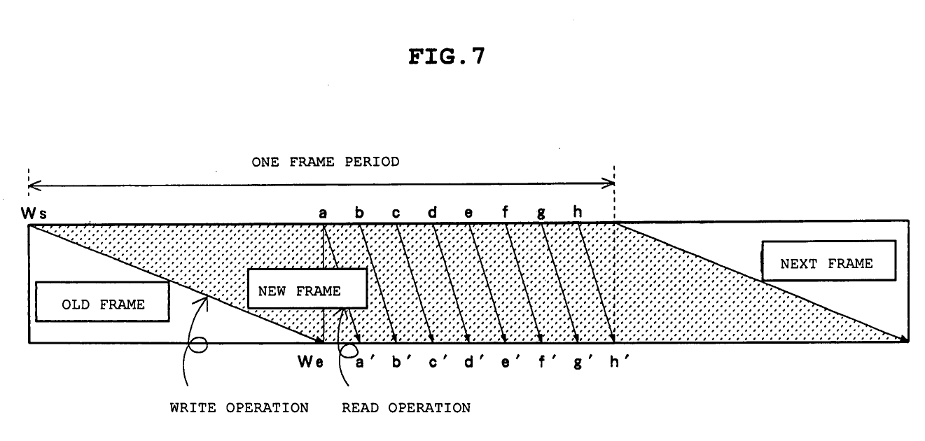

FIG. 7 is a timing diagram explaining the first embodiment of the write and read operations of display data executed in the structure shown in FIGS. 3 to 6. The write operation of display data shown in this FIG. 7 operates to be completed for example during a first half of one frame. That is, in FIG. 7, reference character Ws shows implementation start timing of the write operation of the display data, and reference character We shows implementation end timing of the write operation of the display data.

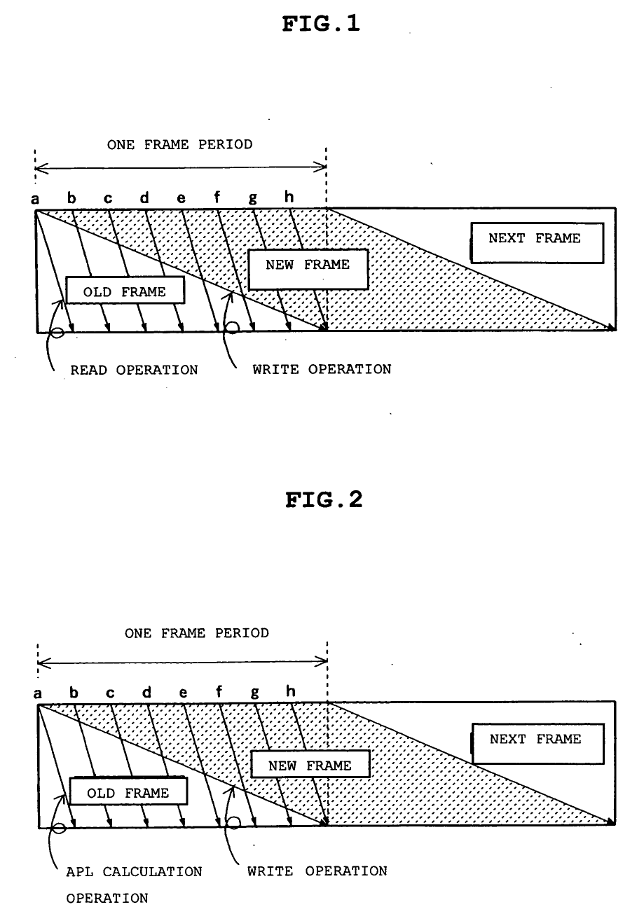

This can be realized by allowing the operation of the A/D converter circuit 12 shown in FIG. 3 and the data write operation to the frame memory 13 to be advanced, that is, by employing a higher speed operation clock with respect to the operation example shown in FIG. 1.

The implementation start of a first read operation of the display data during the one frame period is implemented at the timing shown by reference character a, and the implementation end of its read operation is implemented at the timing shown by reference character a′. In this manner, the implementation start timing a of the read operation is set to be after the implementation start timing Ws of the write operation, and the implementation end timing a′ of the read operation is set to be upon or after the implementation end timing We of the write operation. Following that, the read operation is implemented a plurality of times during one frame period as shown by b, b′ to h, h′.

That is, the number of times of the implementation of the read operation of the display data corresponds to the number of subframes. Operation is performed such that the display data read out of the frame memory 13 a plurality of times is supplied from the light emission control circuit 11 shown in FIG. 3 to the data driver 22 in order to be displayed for each subframe on the display panel 31.

The write and read operations of the display data shown in FIG. 7 are set such that the read operation does not get ahead of the write operation, and therefore the generation of tearing already described can be prevented.

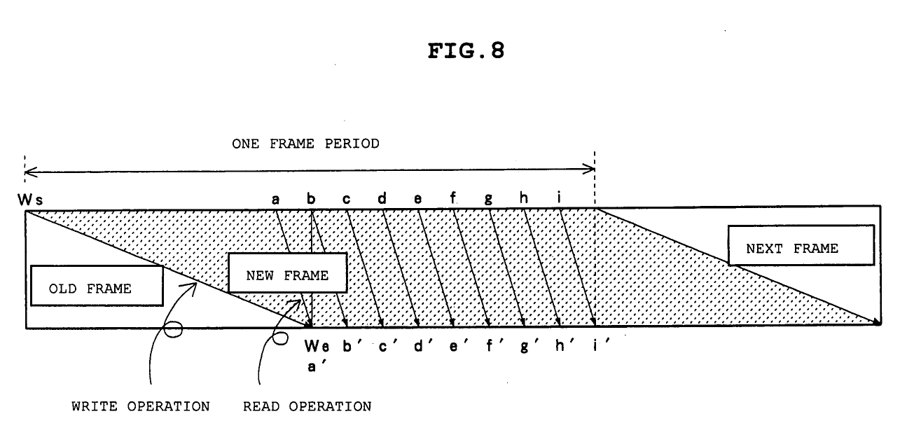

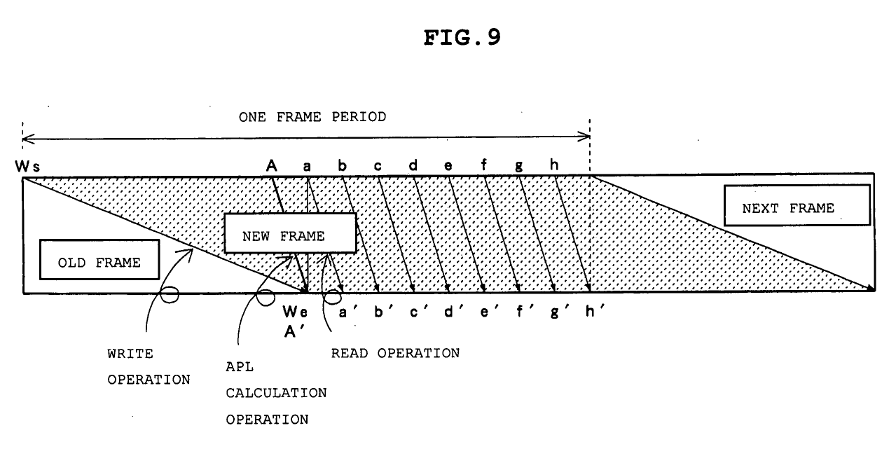

Next, FIG. 8 is a timing diagram explaining a second embodiment of the write and read operations of the display data executed in the structure shown in FIGS. 3 to 6. The write operation of the display data shown in this FIG. 8 also is completed for example during a first half of one frame period, and this is similar to the example shown in FIG. 7.

In the example shown in FIG. 8, the implementation start of a first read operation of the display data during one frame period is made at the timing shown by reference character a in FIG. 8, and the implementation end of its read operation is set so as to be the same as the implementation end timing We of the write operation as shown by reference character a′. The read operation of the display data is implemented a plurality of times during one frame period as shown by b, b′ to i, i′.

Operation is performed such that the display data read out of the frame memory 13 a plurality of times is supplied from the light emission control circuit 11 shown in FIG. 3 to the data driver 22 in order to be displayed for each subframe on the display panel 31. This is similar to the operation of the timing diagram shown in FIG. 7.

The write and read operations of the display data shown in FIG. 8 are set such that the read operation does not get ahead of the write operation, and therefore the generation of tearing already described can be prevented.

FIG. 9 is a timing diagram explaining a preferred first example regarding the relationship between the writing of the display data and the APL calculation operation executed in the structure shown in FIGS. 3 to 6. The write operation (Ws, We) of the display data shown in this FIG. 9 also is completed for example during a first half of one frame period, and this is similar to the example shown in FIGS. 7 and 8 already described.

In the example shown in FIG. 9, the APL calculation operation in which the mean intensity level of the display data written in the frame memory 13 during one frame period is calculated is implemented at least one time. In this case, the implementation start timing of the APL calculation operation is shown by reference character A in FIG. 9, and its implementation end timing is shown by reference character A′.

A first read operation of the display data is implemented at the timing shown by reference character a in FIG. 9, and the implementation end of its read operation is at the timing shown by reference character a′. The following read operation of the display data is performed a plurality of times during one frame period as shown by b, b′ to h, h′, and the display operation is performed for each subframe based on the read data as described above.

As shown in FIG. 9, it is set that the implementation start timing A of the APL calculation operation is set to be upon or after the implementation start timing Ws of the write operation of data and prior to the implementation start timing a of the read operation of data, and that the implementation end timing A′ of the APL calculation operation is set to be upon or after the implementation end timing We of the data write operation and upon or before the implementation start timing a′ of the read operation. In the example shown in FIG. 9, the implementation end timing A′ of the APL calculation operation is set so as to be the same as the implementation end timing We of the data write operation.

The APL value calculated during the period of the reference characters A, A′ is employed for the PLE control during one frame period. The PLE control utilizing the APL value is as already described with reference to FIGS. 5 and 6.

By the APL calculation operation performed at the timing shown in FIG. 9, since the APL calculation operation is performed after the write operation of the display data into the frame memory corresponding to one frame period and prior to the read operation of the display data from the frame memory, the APL can be calculated for each frame based on the display data which corresponds to its frame. Accordingly, the APL value in accordance with display data for each frame is utilized, and this can be correctly reflected in the PLE control at the time of display of this frame.

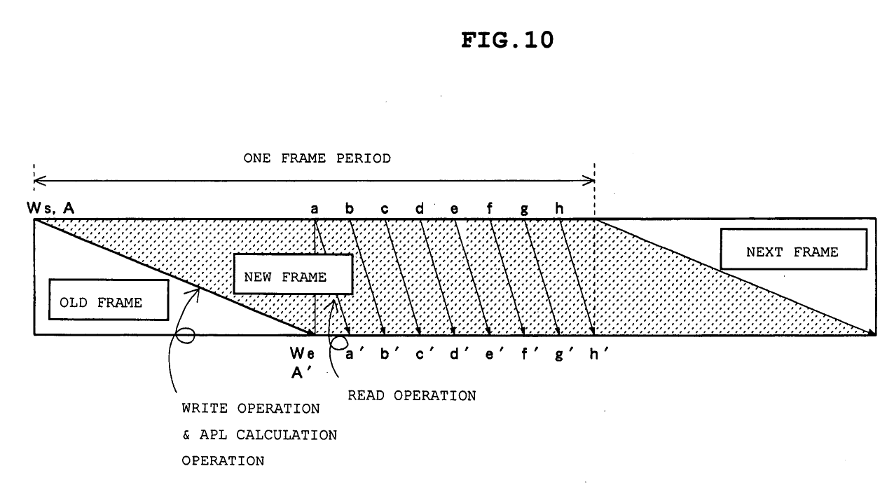

FIG. 10 is a timing diagram explaining a preferred second example regarding the relationship between the writing of the display data and the APL calculation operation executed in the structure shown in FIGS. 3 to 6. The write operation (Ws, We) of the display data shown in this FIG. 10 also is completed for example during a first half of one frame period, and this is similar to the example shown in FIG. 9 already described.

In the example shown in this FIG. 10, the calculation operation of APL (A, A′) is implemented at the same time as the write operation (Ws, We) of the display data. The read operation of the display data is performed a plurality of times during one frame period, as shown by reference characters a, a′ to h, h′ in FIG. 9, and the display operation is performed for each subframe based on the read data as described above.

Accordingly, in the example shown in this FIG. 10, similarly to the example shown in FIG. 9, the APL value in accordance with the display data for each frame can be calculated, and this can be correctly reflected in the PLE control at the time of display of this frame.

1. A drive device of a display panel in which a write operation for writing display data into a frame memory and a read operation for reading the display data written in the frame memory are performed during one frame period, characterized in that
an implementation start timing of the read operation is set to be after an implementation start timing of the write operation, and in that
an implementation end timing of the read operation is set to be upon or after an implementation end timing of the write operation,
wherein the read operation is performed a plurality of times during one frame period.

2. The drive device of the display panel according to claim 1, wherein a plurality of subframes exist in one frame period.

3. The drive device of the display panel according to claim 2, wherein the number of times of the implementation of the read operation corresponds to the number of the subframes.

4. The drive device of the display panel according to any one of claims 1 to 3, wherein an APL operation in which a mean intensity level of display data written in the frame memory is calculated is performed at least one time during one frame period.

5. The drive device of the display panel according to claim 4, wherein the implementation start timing of the APL calculation operation is set to be upon or after the implementation start timing of the write operation and prior to the implementation start timing of the read operation, and wherein the implementation end timing of the APL calculation operation is set to be upon or after the implementation end timing of the write operation and upon or before the implementation start timing of the read operation.

6. The drive device of the display panel according to claim 4, wherein the APL calculation operation is performed at the same time as the write operation.

7. The drive device of the display panel according to any one of claims 1 to 3, wherein a display operation for displaying an image on the display panel is performed at the timing in synchronization with the read operation.

8. The drive device of the display panel according to claim 4, wherein a display operation for displaying an image on the display panel is performed at the timing in synchronization with the read operation.

9. The drive device of the display panel according to claim 5, wherein a display operation for displaying an image on the display panel is performed at the timing in synchronization with the read operation.

10. The drive device of the display panel according to claim 6, wherein a display operation for displaying an image on the display panel is performed at the timing in synchronization with the read operation.

11. A drive method of a display panel in which a write operation for writing display data into a frame memory and a read operation for reading the display data written in the frame memory are performed during one frame period, characterized in that
an implementation start timing of the read operation is set to be after an implementation start timing of the write operation, and in that
an implementation end timing of the read operation is set to be upon or after an implementation end timing of the write operation,
wherein the read operation is performed a plurality of times during one frame period.

12. The drive method of the display panel according to claim 10, wherein a plurality of subframes exist in one frame period.

13. The drive method of the display panel according to claim 11, wherein the number of times of the implementation of the read operation corresponds to the number of the subframes.

14. The drive method of the display panel according to claim 10, wherein an APL operation in which a mean intensity level of display data written in the frame memory is calculated is performed at least one time during one frame period.

15. The drive method of the display panel according to claim 13, wherein the implementation start timing of the APL calculation operation is set to be upon or after the implementation start timing of the write operation and is prior to the implementation start timing of the read operation, and wherein the implementation end timing of the APL calculation operation is set to be upon or after the implementation end of the write operation and upon or before the implementation start timing of the read operation.

16. The drive method of the display panel according to claim 13, wherein the APL calculation operation is performed at the same time as the write operation.

17. The drive method of the display panel according to claim 10, wherein a display operation for displaying an image on the display panel is performed at the timing in synchronization with the read operation.

18. The drive method of the display panel according to claim 13, wherein a display operation for displaying an image on the display panel is performed at the timing in synchronization with the read operation.

19. The drive method of the display panel according to claim 14, wherein a display operation for displaying an image on the display panel is performed at the timing in synchronization with the read operation.

20. The drive method of the display panel according to claim 15, wherein a display operation for displaying an image on the display panel is performed at the timing in synchronization with the read operation.
